(19) United States
(12) Patent Application Publication
(10) Pub. No.: US 2005/0091367 A1
(43) Pub. Date: Apr. 28, 2005

(54) System and method for tracking content communicated over networks

(75) Inventors: Seppo Pyhalammi, Helsinki (FI); Kaj Haggman, Espoo (FI)

Correspondence Address: Crawford Maunu PLLC, Suite 390, 1270 Northland Drive, St. Paul, MN, 55120, US

(73) Assignee: Nokia Corporation

(21) Appl. No.: 10/692,377

(22) Filed: Oct. 23, 2003

(51) Int. Cl. G06F 15/173

(52) U.S. Cl. 709/224; 713/201

(57) ABSTRACT

A system, apparatus and method for tracking content communicated over a network. Users can have content registered and tracked in order to show the popularity of the content for a community of users. Content transmitted over the network is marked and registered such that subsequent transmission, such as through message forwarding, can be recognized as the messages proliferate the network. A bonus or other reward may be provided to users whose content proves to be popular, which can be determined by the number of times the content was transmitted and/or forwarded.

### FIELD OF THE INVENTION

This invention relates in general to network communications, and more particularly to a system and method for providing incentives to users to create and distribute content over a network, by tracking the content created and communicated by users over the network, and providing a bonus or reward to such users when the system is so configured.

### BACKGROUND OF THE INVENTION

Advances in networking infrastructures, protocols, and user devices have significantly enhanced communications. Wireless technologies have allowed society to be mobile, without losing the ability to communicate with one another. A large segment of society now carries their mobile devices with them wherever they go. These mobile devices include, for example, mobile phones, Personal Digital Assistants (PDAs), laptop/notebook computers, and the like. The popularity of these devices and the ability to communicate wirelessly has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow voice communication, but also facilitate messaging, multimedia communications, e-mail, Internet browsing, and access to a wide range of wireless applications and services.

Messaging services have become particularly popular. Through messaging services, wireless and landline communication devices can communicate quickly and conveniently. The launching of the Short Message Service (SMS) evolved into an extremely successful data service, and the Multimedia Messaging Service (MMS) is an evolutionary step from SMS that is poised to enjoy even greater success. Whereas pre-MMS technologies such as SMS and Enhanced Messaging Service (EMS) are limited to the transfer of content such as text, ringing tones, and monochrome bitmap pictures, MMS provides the opportunity to utilize a wide variety of rich content types such as color pictures, audio, music, video clips, Java games, and the like. MMS is based upon a store and forward model, whereby content is first transferred from one network node to a storage location, with subsequent delivery made to another network node.

Mobile and desktop communication devices have ever-increasing capabilities to generate content that may be communicated using messaging services such as MMS. For example, some mobile phones and PDAs are now equipped with digital cameras, allowing users to create images and even video clips using their mobile devices. The ability to create and/or transmit such rich content is certainly appealing to users, and users often want to share their created content with other users. With services such as MMS, such content sharing is currently a reality.

However, the mobile ecosystem is continually seeking ways to increase users' willingness to communicate information and messages. User-generated content has great potential for increasing the content and service offering, thereby increasing the average revenue per user (ARPU) for network operators. It would be desirable, however, to provide further incentives for users to send messages. To move towards such a goal, the threshold for users to create and send messages/content should be reduced as much as possible to increase the likelihood that messages will be sent, and to increase the likelihood that messages received by users will be forwarded on to other users. For example, a popular image sent by a user to another user may create a network traffic snowball effect as the image is proliferated through the network from user to user. It would therefore be desirable to create incentives for users to create content that has a high potential for being proliferated in such a manner.

Accordingly, there is a need for a manner of providing incentives for users to create and distribute content over a network. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system, apparatus and method for tracking content communicated over a network. The present invention allows a user to have content registered and tracked in order to show the popularity of the content for a community of users. Content transmitted over the network is marked and registered such that subsequent transmission (e.g., repeated forwarding of the content from user to user) can be recognized, and in some cases a bonus or other reward is provided to users whose content proves to be popular and is forwarded from user to user.

In accordance with one embodiment of the invention, a method is provided for tracking content communicated over a network. The method includes receiving a message(s) and associated content from an originator of the content over the network. A watermark is associated with the content. The watermarked content is registered to record an association of the watermarked content with the originator of the watermarked content. Subsequent transmission of the watermarked content over the network is monitored to identify the originator of the watermarked content, and a content transmission count is maintained for each of the originators of the watermarked content that is transmitted over the network.

In more particular embodiments of such a method, statistics such as the content transmission count and associated content originator may be sent to a server where such statistics can be presented. Based on these statistics, a bonus or other reward may be generated for the originator of the watermarked content. The bonus may include, for example, providing the originator of the registered content with a reduced network access charge, free network access, a prize, a monetary reward, publicity, or the like.

In other particular embodiments of such a method, associating a watermark with the content involves embedding electronically perceivable data into the content. This may be accomplished by, for example, encrypting at least some content attributes to provide encrypted data, hashing at least some of the content attributes to provide a machine authentication code (MAC), and executing a watermark algorithm using the content, the encrypted data, and the MAC as inputs to the watermark algorithm. In still other particular embodiment, detection data may be associated with the watermarked content, where monitoring for subsequent transmission of the watermarked content includes detecting the detection data, and verifying the watermark data for the watermarked content that includes the detection data. In one embodiment, such detection is performed at a message routing entity, such as an MMSC. When the MMSC forwards a detected message and forwards it to the message tracking system, the watermark data may be verified, and the originator of the watermarked content can be identified from the registration information. Using this information, the number of times in which a particular watermarked content item is transmitted via the MMSC can be tracked, and a bonus may be provided to the originating user.

In accordance with another embodiment of the invention, a method is provided for tracking content communicated via Multimedia Messaging Service (MMS) messages over a network. The method includes receiving MMS messages communicated over the network at a Multimedia Messaging Service Center (MMSC), and forwarding the MMS messages to a message tracking system. At the message tracking system, a watermark is associated with the content provided via the MMS messages. The watermarked content is registered to record an association of the watermarked content with an originator of the watermarked content. Subsequent MMS transmission of the watermarked content is monitored to identify the originator of the watermarked content. A content transmission count is maintained for each of the originators of the watermarked content that is transmitted over the network.

In accordance with another embodiment of the invention, a message tracking system is provided. The message tracking system is coupled to receive messages and associated content from a message routing entity over a network. The system includes a processing system, and various modules operative with the processing system. A watermarking module is configured to associate watermark data with the content to generate watermarked content, and a registration module is configured to register the watermarked content as being received at the message tracking system. A watermark verification module is configured to recognize watermarked content that has been previously registered, and the registration module tracks the number of times in which the previously registered watermarked content has been received at the message tracking system for each originator of the watermark data.

In accordance with another embodiment of the invention, a system is provided for tracking content communicated via messaging between devices operable on a network. The system includes a message center coupled to the network to receive messages and associated content from message source devices targeted for one or more message destination devices. A message tracking system is coupled to receive the messages and associated content from the message center. The message tracking system includes a processing system, and various modules operative with the processing system. A watermarking module is configured to associate watermark data with the content to generate watermarked content, and a registration module is configured to register the watermarked content as being received at the message tracking system. A watermark verification module is configured to recognize watermarked content that has been previously registered, and the registration module tracks the number of times in which the previously registered watermarked content has been received at the message tracking system for each originator of the watermark data.

In more particular embodiments of such a system, the messages and associated content are provided via Multimedia Messaging Service (MMS) messages, and the message center includes a Multimedia Messaging Service Center (MMSC) (which may include one or more MMSC servers). Detection data may be associated with the content such that the MMSC can detect such content when the content is being transmitted from user to user via the MMSC.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a diagram illustrating the tracking of content that has proliferated a network in accordance with the present invention;

FIG. 2 is a flow diagram illustrating one exemplary manner for tracking content communicated over a network in accordance with the present invention;

FIG. 3 is a flow diagram illustrating another embodiment for tracking content and acting on content proliferation results in accordance with the present invention;

FIG. 4 is a block diagram of an exemplary embodiment of a system for tracking message proliferation in a mobile network environment;

FIG. 5 is a flow diagram illustrating one embodiment of a message tracking and bonus generation methodology in accordance with the principles of the present invention;

FIG. 6 illustrates an embodiment for perpetuating message proliferation, where users can obtain the message/content from other sources rather than from being a recipient of a forwarded message;

FIG. 7 illustrates one example where popular content stored via a WAP site, web site, or other network site can be ordered and sent to other users in accordance with one embodiment of the invention;

FIG. 8 is a block diagram illustrating one representative manner in which content may be watermarked in accordance with the present invention;

FIG. 9 illustrates a representative manner for registering content with a message tracking system and subsequently recognizing watermarked content in accordance with one embodiment of the invention;

FIG. 10 is a flow diagram illustrating another embodiment of a manner for tracking messages in accordance with the present invention, where registration is separately performed;

FIG. 11 is a flow diagram illustrating an embodiment of a manner for tracking messages in accordance with the present invention, where a separate marking site is accessed to facilitate access to the message tracking system; and

FIG. 12 is a block diagram of a representative computing architecture capable of carrying out functionality of a message tracking system in accordance with the invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a system, apparatus, and method for tracking content communicated over a network. Content sent via messages are digitally watermarked and registered so that the content can be tracked if it is subsequently forwarded over the network. Monitoring for any such subsequent content transmissions from user to user is performed, to identify the originator of the registered content. Statistics may be maintained on the message proliferation, and rewards or other bonuses may be provided to users whose content is forwarded, and possibly repeatedly forwarded, by targeted recipients of the content. In this manner, content originators can be rewarded for transmitting what proves to be popular content over the network.

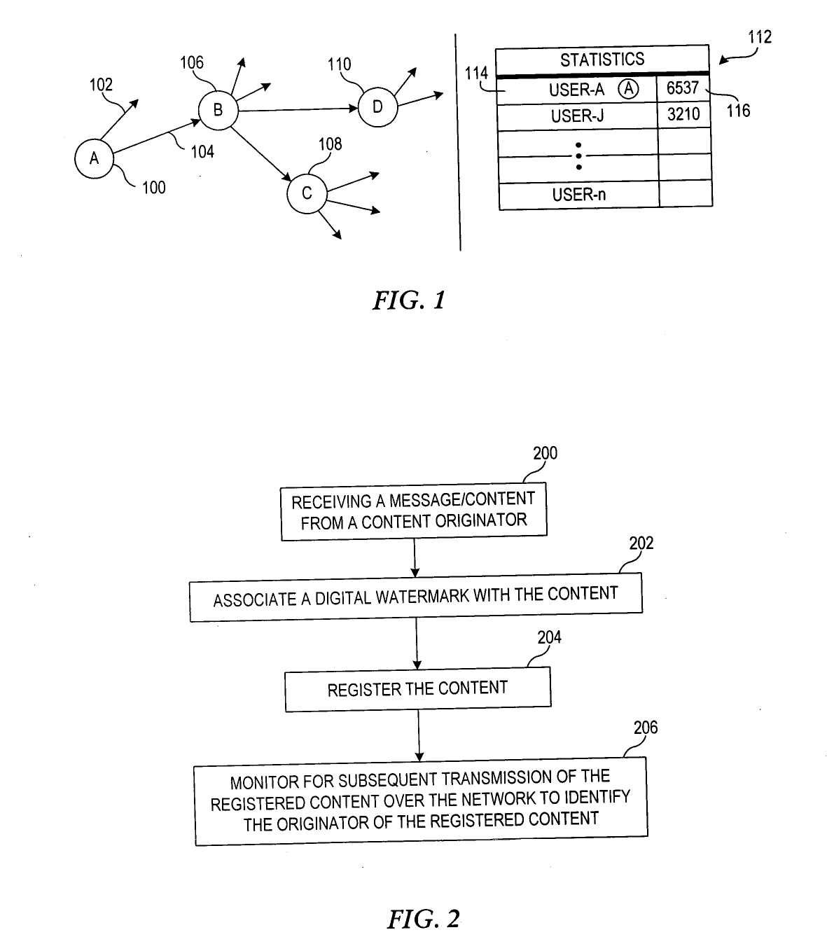

In accordance with the invention, the popularity of mobile content and messages can be tracked. The popularity of content associated with a particular message may be determined by, for example, monitoring the degree of proliferation of the message through the network. FIG. 1 is a diagram illustrating the tracking of content that has proliferated a network. In the illustration of FIG. 1, user-A 100 may create content or otherwise initiate a transfer of content via a corresponding communication terminal. For example, the user may create a digital image using a camera-equipped mobile device, or may create an audio file, ringtone, video, text message such as a joke, document, or the like. User-A 100 may then transfer this content over a network to one or more other communication terminal users, as illustrated by transfer lines 102, 104. The content may be transferred in a variety of manners, such as by sending messages, including Multimedia Messaging Service (MMS) messages or other similar messages capable of transferring multimedia content.

While user-A 100 may only transfer the message (including the content) to one or more other users, the users receiving the message may in turn forward the message to still other users. For example, user-B 106 may receive the message from user-A 100, and forward the message to other users including user-C 108 and user-D 1 10. Each of these recipients may again forward the message to other users. In this manner, the original message originating at the communication device of user-A 100 is proliferated throughout the network.

The success of such message proliferation will generally depend on the popularity of the content being transmitted. For example, if user-A 100 sends a message with an interesting, humorous, artistic or otherwise well-liked image attached thereto, there is a greater likelihood that recipients of the message will forward it to other users. Therefore, the degree to which a message/content is forwarded provides a measure of the popularity of the transmitted content. In accordance with the invention, such content popularity can be tracked, and in some embodiments rewards, discounts, or other bonus activity may be provided to originators of such popular content.

According to one embodiment of the invention, the popularity of the image or other content created by a user is recorded, and popularity statistics may then be made available via the network. For example, content popularity statistics or other content proliferation results relating to the popularity of transmitted content may be presented by way of the network, such as via a web site, Wireless Application Protocol (WAP) site, or other similar site. In the illustrated example, a table 112 is presented via a WAP/web site, which identifies the originator 114 of the content (corresponding to user-A 100 in the illustrated embodiment) and a count value 116 corresponding to the degree at which the message/content was forwarded throughout the network. The count value 116 may represent the number of recipients receiving the message, or the number of times the message was forwarded, or other predetermined criteria. The statistics presentation, a table 112 in the illustrated embodiment, may present the statistics in any desired order, and may include any desired number of users. For example, a top ten list may be presented, where the top ten proliferated content items and corresponding content originators are presented in an order from the highest proliferated content item to the lowest of those top ten.

Rewards or other bonus activity may be provided to any one or more of the users who originate and/or forward such content, as described more fully below. In this manner, the popularity of content and messages can be tracked, allowing active and creative users to be rewarded.

FIG. 2 is a flow diagram illustrating one manner for tracking content communicated over a network in accordance with the present invention. A message and associated content is received 200 from an originator of the content over a network. For example, an MMS message may be transmitted from the user equipment of a user to a message tracking system by way of a Multimedia Messaging Service Center (MMSC).

The message may be in transit targeted for one or more other users, or alternatively may be directed to the message tracking system to register the content as described more fully below. The content may be created at the user equipment (UE) of the user, such as the user taking a picture using a camera-equipped mobile phone, creating textual content such as a joke using a text editor/word processor on the user's device, or the like. Alternatively, the content may be created by the user on another system, and uploaded to the UE for transmission over the network.

The message tracking system associates a digital watermark with the content as shown at block 202. In one embodiment, marking the content in such a manner involves embedding electronically perceivable data into the content. The digital watermark may be created by, for example, encrypting one or more attributes of the content to provide encrypted data, and/or providing a hashing function to hash one or more of the content attributes to provide a machine authentication code (MAC). The results may be processed by a watermarking algorithm. More particularly, the attributes of the content may include a subscriber identity such as a Mobile Station Integrated Services Digital Network (MSISDN) number, a message timestamp, the original content itself, and/or other attributes. The watermarking process results in digitally watermarked content. Various implementation examples are described in greater detail below.

The content is registered 204 to record an association of the content with the originator of the content. For example, content may be registered in a registration database, where a database record includes at least a subscriber identity (e.g., MSISDN) of the content originator and some representation of the content. Where the content is an image, the representation of the content may be a thumbnail image or other auxiliary representation of the image, a filename for the image or thumbnail image, or the like. Other information may also be included in the registration, such as a message timestamp, a MAC, etc. Further, a count value corresponding to the number of times the content has been transmitted over the network is maintained. Such a count value tracks the proliferation of the message/content over the network, and is described in greater detail below.

By watermarking 202 and registering 204 the content in such a manner, messages can be tracked. In accordance with the present invention, the message tracking system monitors 206 for subsequent transmission of the registered content over the network. In this manner, the originator of the registered content can be identified in the registration database, and the message count for that user/content can be properly updated each time the message is sent over the network. In one embodiment, one or more detection bits are provided with the content during the watermarking 202 process, where these detection bits can be detected in content as messages are communicated over the network. If a message center such as an MMSC recognizes such detection bits, the message can be forwarded to the message tracking system where the digital watermark can be verified. The message tracking system may verify the digital watermark by, for example, extracting watermark data included with the content during a previous watermarking event, and comparing some or all of the extracted data with information in the registration database. If a match is found, the watermark verification is successful. Where encryption and/or hashing is used in creating the watermark in the first place, the watermark verification process will properly decrypt the encrypted information to obtain the plain text information for comparison to the registration database.

In accordance with the present invention, statistics may be gathered relating to the registered content. For example, a message transmission count value may be stored and updated as the registered content is recognized when the message is forwarded or otherwise proliferated through the network. These statistics may be forwarded to a server, such as a web or WAP server, where the statistics can be presented on a WAP/web site hosted by the server. Such statistics may be presented in a hierarchical order, showing the message proliferation results of users relative to one another.

One beneficial aspect of tracking the proliferation of messages and associated content over the network is to provide the content originators with a bonus or reward for submitting popular content on the network. For example, popular messages may be forwarded from user to user, and registered messages will be recognized by the message tracking system. Based on the statistics of such message proliferation, rewards or other bonuses may be provided to the originators of these popular messages. In one embodiment, the reward/bonus is based at least in part on the volume of the registered messages/content that is transmitted over the network. The bonus may include, for example, a reduced network access charge for the content originator, free network access (for a period of time, until some predetermined event, etc.), prizes, monetary rewards, publicity, and the like. The bonus may be based on raw data and independent of the volume of other users, or alternatively may be based on the relative volumes of different users (e.g., bonus provided to the top one hundred content originators).

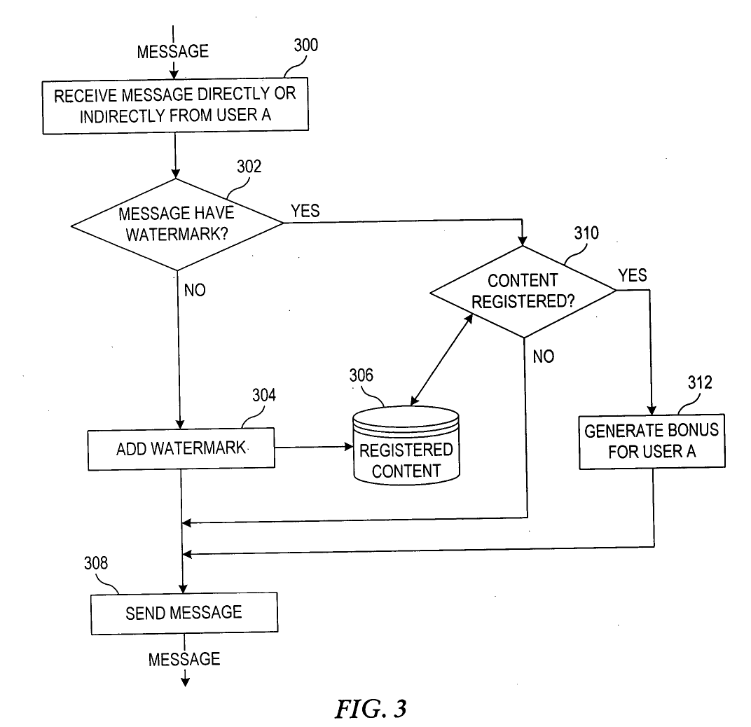

FIG. 3 is a flow diagram illustrating another embodiment for tracking content and acting on content proliferation results in accordance with the present invention. A content tracking system receives 300 a message. This message may be from a content originator such as user-A, or from another user who has directly or indirectly received the message/content originated by user-A. It is determined 302 whether the message has been “watermarked” or otherwise marked to enable its tracking. This “watermark” generally refers to some embedded, electronically perceivable data that allows the message to be tracked by the message tracking system. If the message is not watermarked as such, a watermark is added 304, and the content is stored as registered content at, for example, a registered content database 306. The message is then sent 308 to the targeted recipient. Once watermarked 304 and registered 306, further proliferation of the message can be tracked.

If it is determined 302 that the received message includes a watermark, it is determined 310 whether the content has been registered with the system. This can be determined by accessing the registered content database 306. If the content is not registered, the message is sent 308 to the targeted recipient. If the content is registered, one embodiment of the invention allows a bonus or other reward to be generated 312. For example, the network operator may provide the user with a discount to his/her bill, and/or may provide coupons, prizes, public recognition, or the like.

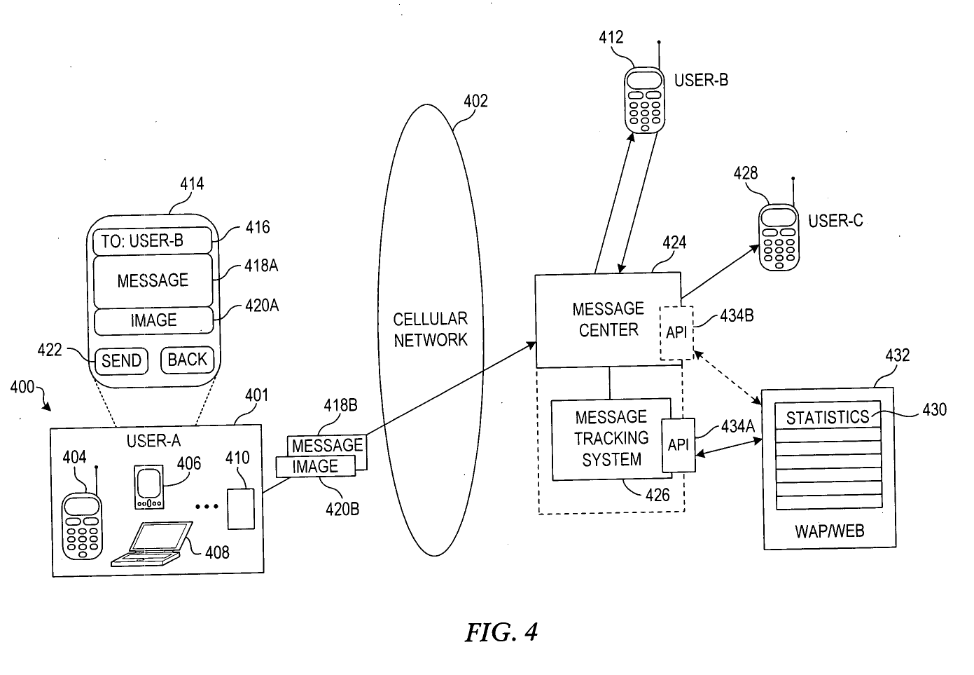

FIG. 4 is a block diagram of an exemplary embodiment of a system for tracking message proliferation in a mobile network environment. In the illustrated embodiment, it is assumed that at least some of the communication devices are mobile devices that communicate wirelessly with other devices over a network. User-A 400 therefore uses his/her mobile device 401 to create or otherwise obtain content for transmission over the network. The mobile device 401 may be any device capable of communicating wirelessly with a network such as the cellular network 402, and may include devices such as a mobile phone 404, Personal Digital Assistant 406, portable computing device 408, or other wireless device 410.

For example, user-A 400 may create an image using a digital camera function available on his/her mobile phone 404. User-A 400 then sends a message, including the created image (or other content) targeted for another user, such as user-B 412. User-A 400 may send this message in any known manner. For example, the mobile phone 404 includes a user interface (UI) 414 which may be presented upon activation of the messaging client application/user agent at the mobile phone 404. Using the UI 414 associated with the client, User-A 400 may select the address of user-B 412, as depicted at the address field 416 of the UI 414. User-A 400 may then add a message 418A, and the created image 420A. By selecting the appropriate UI 414 mechanism such as selecting the “send” button 422 (e.g., physical UI button, graphical UI button, etc.), the message 418B and associated image 420B are sent towards the user-B 412 via the cellular network 402.

The message 418B and image 420B are directed to a message center module 424 that performs, among other things, routing of messages between users. The message center module 424 may be implemented as a network server coupled to the wireless network, or alternatively may be coupled to a data network such as a General Packet Radio Service (GPRS) network, the Internet, or other data network that is operatively coupled to the wireless network 402. In one embodiment of the invention, the message 418B and associated content 420B is provided via the Multimedia Messaging Service (MMS), and the message center 424 represents a Multimedia Message Service Center (MMSC). MMS supports transmission of at least text, images, video and audio, and an MMS message 418B will include the content 420B. A message is sent to the MMSC 424, which in turn directs the message to the appropriate target device, user-B 412 in the illustrated embodiment. An MMSC provides messaging capabilities for the delivery of multimedia messages including text, photographs, video, and/or other media types. The messaging capabilities include mobile-originated messages sent to other mobile terminals or applications. The MMSC 424 is responsible for storing incoming and outgoing MMS messages, as well as transferring messages between different messaging systems, e.g., an e-mail service. In addition, MMSC 424 may provide an External Application Interface (EAIF) (not shown) that allows application developers and service providers to connect to the MMSC 424 to offer value-added services to mobile subscribers.

In accordance with the present invention, the MMSC or other message center 424 works in connection with a message tracking system 426 to watermark and register the message. By watermarking and registering the image, the proliferation and consequently the popularity of the message 418B/420B can be tracked, and statistics regarding the proliferation of the message 418B/420B may be gathered and stored. The message tracking system 426 may be implemented as a stand-alone system that can communicate with the message center 424 over a network, or alternatively may be implemented as part of the message center 424. For example, where the message center 424 represents an MMSC, the message tracking system 426 may be implemented as part of the MMSC system, or may be separately implemented and accessible to the MMSC.

After watermarking/registering the message, the message center 424 delivers the message to the targeted recipient, user-B 412. User-B 412 receives the message 418B, may view the message/content, and may decide to forward it to other users. Thus, if the image provided with an MMS message is interesting, humorous, artistic, or otherwise such that user-B 412 decides to forward the message to other users, user-B 412 will forward the message targeted for such other users, such as user-C 428. The message center 424 receives the message targeted for user-C 428, and via the message tracking system 426 the watermark for the image is verified. If the message was previously sent elsewhere as is the case in the illustrated embodiment, a reward, discount, or other bonus may be created for the content originator user-A 400. The message center 424 then delivers the message to the targeted recipient user-C 428.

The message tracking system 426 records updated statistics regarding the message, such as incrementing a count value corresponding to the number of times in which that message/content has been forwarded to other users. The message center 424 in connection with the message tracking system 426 determines such information, which can be presented to user-A 400 and any other users. In the illustrated embodiment, the statistics results 430 are posted via a WAP/web site 432 or other network site accessible by the users. Therefore, the images or other content that prove to be the most popular or otherwise generate the most traffic may be presented, such as by way of the WAP/web site 432. In one embodiment, these usage statistics are gathered by the message tracking system 426 and made available to the site 432 through an interface, such as an Application Programming Interface (API) 434A. Alternatively, the message center 424 may include such an API 434B such that the statistics are provided from the message tracking system 426 to the message center 424 and ultimately to the site 432 via API 434B. Users can then access the site 432 to view statistics and/or determine their own statistics or relative statistics of various users. Other manners of presenting this information may also be employed in accordance with the present invention, such as sending messages, e-mails, or other communications to the relevant users. Based on the statistical information of the various users, rewards or other bonuses may be provided to the users, as will be described more fully below.

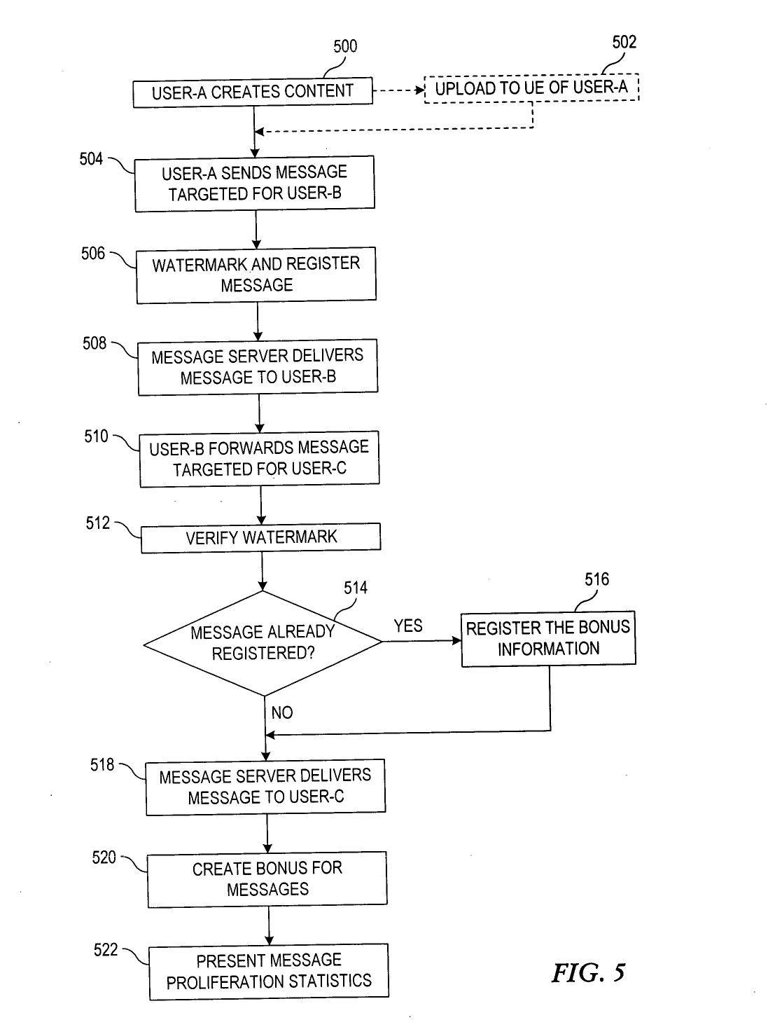

FIG. 5 is a flow diagram illustrating one embodiment of a message tracking and bonus generation methodology in accordance with the principles of the present invention. In the illustrated embodiment, the user-A creates 500 content, such as creating an image using a camera-enabled mobile device, recording an audio message or ringtone, or the like. Alternatively, user-A can generate or otherwise obtain such content elsewhere, and upload 502 the content to the user equipment (UE) used by user-A. User-A sends 504 the message targeted for one or more other users, including user-B in the illustrated embodiment.

In accordance with one embodiment of the invention, the user-A sends 504 an MMS message that includes the content. In such a case, the MMS message is directed to the recipient user via an MMSC. Other network entities that assist in the routing and/or management of message transfers over the network may alternatively be used. E-mail servers or other network- entities may also be involved depending on the type of message sent by the user.

The MMSC or other message server receives the message(s), and causes the message to be watermarked and registered by way of a message tracking system, as shown at block 506. For example, the MMSC may deliver the message to the message tracking system which in turn watermarks and registers the message. The MMSC or other message server delivers 508 the message to the targeted user-B. User-B may then forward 510 the message targeting at least user-C (and perhaps one or more other users). The MMSC or other message server receives the message, and verifies 512 the watermark using the message tracking system. If the message has already been registered with the message tracking system as determined at decision block 514, the message tracking system registers 516 bonus information. For example, the message tracking system will locate a corresponding message originator in its local registers/database, and will register receipt of the message by, for example, updating the bonus information such as a message transmission count value. The MMSC or other message server then delivers 518 the message to the targeted user-C, and a reward or other bonus is created 520 for the message(s). For example, based on the message transmission count value, a reward, discount, or other bonus may be created 516 for user-A. As a more particular example, user-A's bill with the network operator may be reduced. The operator of the WAP/web service may then present 522 message proliferation statistics, such as via a WAP/web site.

As indicated above, a “bonus” to a user may potentially reduce the user's bill through the operator, or may otherwise provide some benefit to the user. For example, a user may obtain a linear or non-linear reduction in a usage or network access bill for each predetermined number of messages that are forwarded over the network. The predetermined number may be one, such that the user is awarded a bill discount for each forwarded message. The predetermined number may be some number greater than one, or may even change depending on the volume or other criteria. For example, a user may obtain a discount for each message forwarded up to a total of one hundred messages, and then receive additional discounts for every five forwarded messages after that. As another example, the bonus may be non-linear, such that the user obtains an increasing benefit as the message transmission volume increases, or on the other hand may receive a decreasing benefit as the message transmission volume increases. Further, in lieu of (or in addition to) bill-reducing bonuses, other rewards or bonuses may be provided. For example, coupons, monetary rewards, free operator service, prizes, or other rewards may be provided to users. Any such rewards may be based on each user's usage, or may apply only to some users such as the users associated with the top ten forwarded messages. Any desired bonus plan may be implemented in accordance with the present invention.

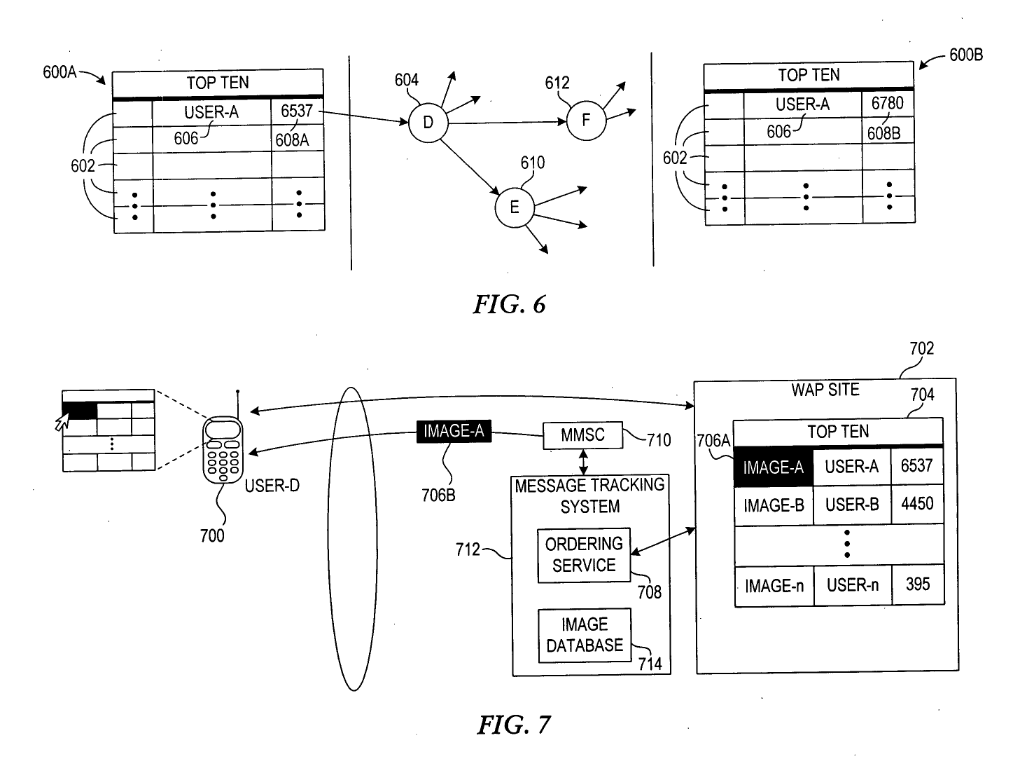

In accordance with one embodiment of the present invention, message proliferation may occur as a result of repeated forwarding of a message(s) from user to user, thereby creating a “snowball” effect. However, the present invention provides additional manners for facilitating such message proliferation. FIG. 6 illustrates one such manner, where users can obtain the message/content from other sources rather than from being a recipient of a forwarded message. In the embodiment of FIG. 6, message proliferation statistics are presented via a WAP, web, or other network site 600A. These statistics may include all statistics for content registered with the message tracking system of the invention, or any subset thereof. For example, the illustrated embodiment depicts a network site 600A that is a subset of all message proliferation statistics, and includes the “top ten” forwarded messages. This site 600A may be made available to any user of a device capable of connecting to the site 600A, or alternatively may be made available to a subset of users such as those who have registered for use with the message tracking system of the present invention.

In any event, users may browse to the site 600A, and may access the content associated with those users listed on the site 600A. In the case where the content includes images, thumbnail images 602 or other information indicative of the content may be presented. By viewing the images 602 or otherwise investigating the associated content presented via the site 600A, a browsing user may like the content and decide to forward it to another user(s). More particularly, user-D 604 may view a thumbnail image 602 associated with a message originating with user-A 606 whose message forwarding total is currently 6537 as shown at message count field 608A. User-D 604 forwards the message (and image) to other users, including user-E 610 and user-F 612, who may in turn forward it to one or more other users. As a result, the popularity of user-A's 606 image is even higher due to further proliferation of the message. The site 600B is updated, resulting in a higher value (6780) in the message count field 608B. Therefore, message proliferation may also be facilitated by users accessing the message/content from sources other than receiving the message directly from other users, such as by accessing the content from the WAP/web site 600A.

In one embodiment of the invention, users who access the site 600A may be allowed to place an order for the content associated with any of the users presented via the site 600A. FIG. 7 illustrates one example where popular content stored via a WAP site, web site, or other network site can be ordered and sent to other users in accordance with one embodiment of the invention. For example, user-D 700 browses a WAP site 702 that includes a “top ten” list 704 or other message proliferation presentation as described in connection with FIG. 6. The browsing user-D 700 clicks on or otherwise selects a thumbnail image 706A associated with user-A which invokes an ordering service 708.

The ordering service 708 may be associated with the site 702, message server such as MMSC 710, message tracking system 712, or may be provided as a Web Service or the like. After the order has been accepted by the ordering service 708, the actual image 706B associated with the selected thumbnail image 706A is sent (e.g., MMS message) to user-D 700, if the image 706B is stored at the service such as in an image database 714. If the actual image is not stored, the owner of the actual image (user-A in the illustrated example) is notified, such as by way of an SMS or MMS message, e-mail, or the like. User-A can then be provided the opportunity to download the actual image 706B to the system 712 for delivery to the ordering user-D 700. A similar ordering process would be utilized for any other type of content, such as text, documents, audio, video, etc.

In order to properly track messages/content, content is watermarked and registered in accordance with the invention. According to one embodiment, a message tracking system watermarks content created by users, maintains a database of the messages sent, and gathers statistics regarding messages sent and forwarded. By tracking messages through watermarking, the popularity of the messages can be tracked and maintained.

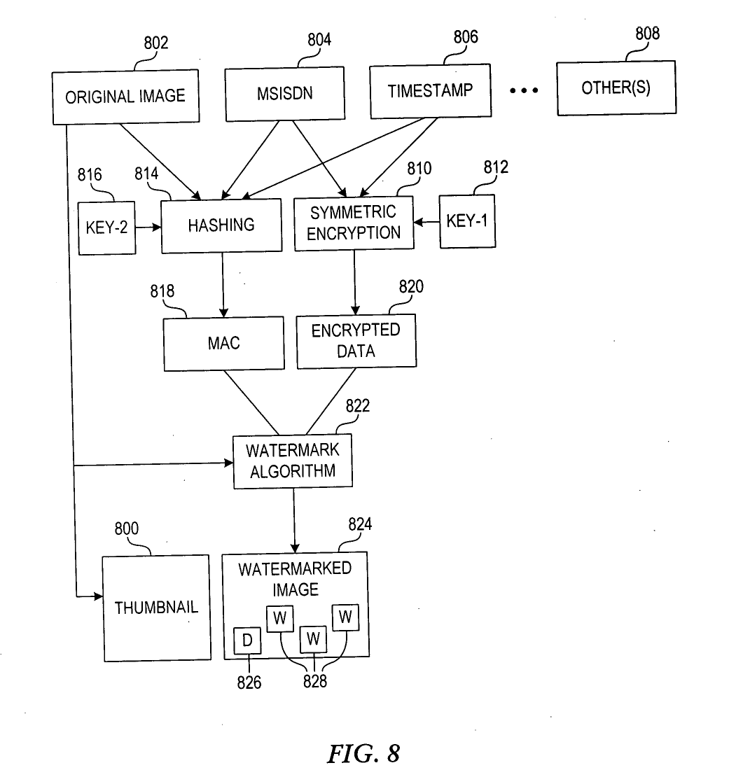

FIG. 8 is a block diagram illustrating one representative manner in which content may be watermarked in accordance with the present invention. For purposes of illustration and not of limitation, FIG. 8 is described in terms of watermarking an image, although watermarking audio, video, text, or other content may be watermarked in an analogous fashion. In the embodiment of FIG. 8, a thumbnail 800 or other representation of the content is created from the original image 802 by the message tracking system. Various information is used as data to perform encryption. In one embodiment, the Mobile Station Integrated Services Digital Network (MSISDN) number 804 associated with the image-generating user is used as part of the input data for the encryption. As is known in the art, the MSISDN is a mobile number used by GSM/DCS networks that contains information such as the country code, national destination code, HLR identifier and a subscriber number. Other analogous subscriber identification numbers may be used instead or in addition to an MSISDN number. Also, a timestamp 806 is used as input data for the encryption. Other information 808 may also be used if desired.

In the illustrated embodiment, the MSISDN 804 and timestamp 806 are used as data for a symmetric encryption algorithm 810 using, for example, a 128-bit key shown as key-1 812. The original image 802, MSISDN 804, and timestamp 806 are used as data for a hashing algorithm 814 using, for example, a 128-bit key shown as key-2 816. The hash function 814 creates a unique fingerprint for its input information. The result of the hashing function 814 and application of the key-2 816 is a machine authentication code (MAC) 818. As is known in the art, a MAC provides a manner of verifying the integrity of transmitted information, based on a secret key which is key-2 816 in the illustrated embodiment. The result of the symmetric encryption function 810 is encrypted data 820, which represents the data encoded by the symmetric encryption function 810 as encrypted with key-1 812. Other manners of encrypting, such as public key encryption, may alternatively be used.

The resulting MAC 818, the encrypted data 820, and the original image 802 are used as input to a watermarking algorithm 822. Any appropriate watermarking algorithm may be used in connection with the present invention. Generally, the watermarking algorithm takes a bit pattern and inserts those bits into the content in question. For example, the bit pattern may be text or other predetermined bit pattern. Assuming the content is an image for purposes of discussion, the bits are inserted into different positions in the image based on the watermarking algorithm. In this manner, only some number of single bits is changed in the image, which is not detectable by the human eye (or otherwise not readily apparent). Different watermarking algorithms may insert different quantities of data, different locations, different groupings/patterns, or the like. These watermarking characteristics may be selected depending on the desires or requirements of the particular watermarking event. For example, where it is important that an image (or other content) be minimally affected to the perception of the viewer, fewer bits and/or a more scattered distribution pattern may be inserted into the image. On the other hand, it may be important to make an image (or other content) less susceptible to subsequent changes in the content, such as image resizing. In such cases, more data patterns and/or bits may be inserted to increase the chance that the watermark will remain viable. Thus, the resulting watermarked image 824 is created with one or more detection bits (D) 826, and the actual watermark bits (W) 828, embedded into or otherwise associated with the image data.

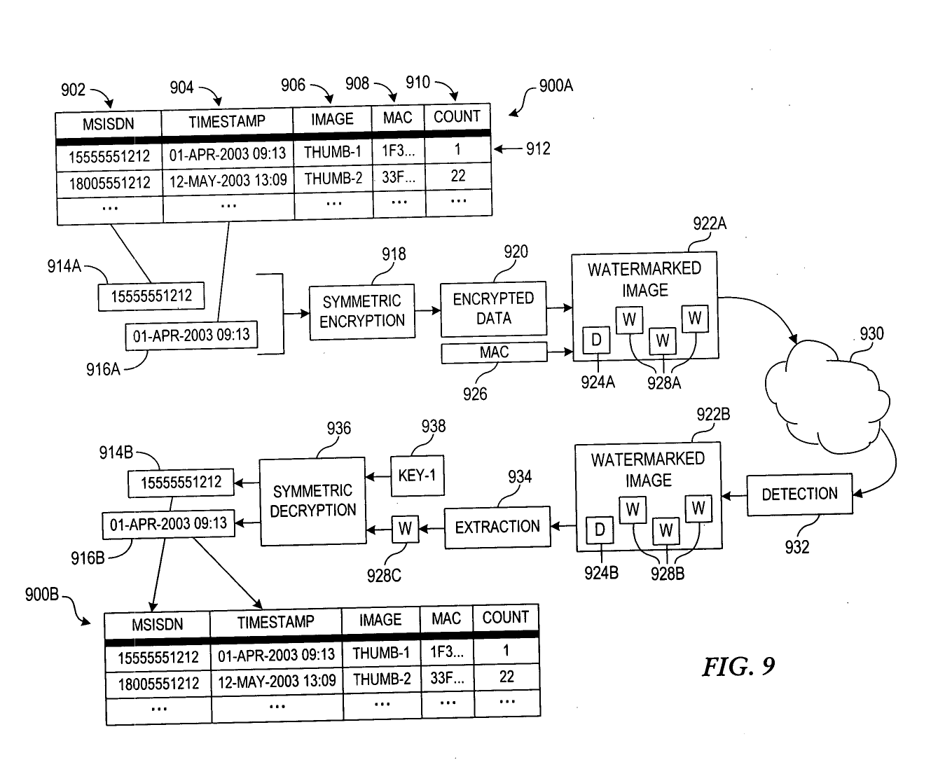

In order for the message tracking system to associate a watermarked image with a user and optionally provide rewards or other bonuses to users, the image (or other content) is registered with the message tracking system. FIG. 9 illustrates a representative manner for registering content with a message tracking system and subsequently recognizing watermarked content in accordance with one embodiment of the invention. In registering the content according to one embodiment of the invention, a database 900A or other storage mechanism associated with the message tracking system may be used to store the MSISDN 902, timestamp 904, thumbnail 906 or other representation of the content, and MAC 908. A counter value 910 is initialized upon first registration of the content. For example, database record 912 identifies the user by the MSISDN 902. The timestamp 904 of 1 Apr. 2003 09:13 indicates that the message was received (or other predetermined event) on Apr. 1, 2003 at 9:13 a.m. The thumbnail 906 (THUMB-1) and the MAC 908 (1F3 . . . ) are stored, and the count value is initialized to a predetermined value such as “1” upon first registration of the image. The count 910 thus indicates the number of times in which the particular image THUMB-1 from the user identified by the corresponding MSISDN 902 has been processed by the message tracking system. Database records may be maintained for each user/image combination, as depicted by the indefinite length database 900A.

Again referring to database record 912, the MSISDN value 914A and timestamp value 916A are obfuscated by the encryption process 918 to produce the encrypted data 920, as described in connection with the description of FIG. 8. Therefore, the MSISDN 914A and timestamp 916A cannot be discovered from the resulting watermarked image 922A. The detection (D) bit(s) 924A are inserted to allow for fast detection of watermarked images. The MAC 926 is used to protect against others tampering with the image/watermark. As set forth above, the MAC 926 and encrypted data 920 are used to create the watermarked image 922A with actual watermark bits 928A.

The message with the watermarked image 922A is then transmitted according to the destination(s) identified in the associated message. For example, an MMSC may deliver the message to the destination MMS clients, as depicted by the transmission of the watermarked image 922A and associated message (not shown) over the network 930. When the MMSC receives a message, it determines whether any associated content includes a watermark. In one embodiment, an MMSC or other message server includes a watermark detection module 932, which recognizes the watermarked image 922B by the detection (D) bits 924B. The message tracking system receives the watermarked image 922B, and an extraction module 934 extracts the watermark (W) 928C from it. The extracted watermark (W) data 928C is decrypted by the symmetric decryption module 936 using the secret key, key-1 938, that is known only by the message tracking system. In this manner, the MSISDN 914B and timestamp 916B are extracted. A comparison of the extracted MSISDN 914B and timestamp 916B is made to the existing database 900B. Upon location of a match in the database 900B, the message tracking system has recognized the image, and can update message proliferation statistics and may generate a reward or other bonus.

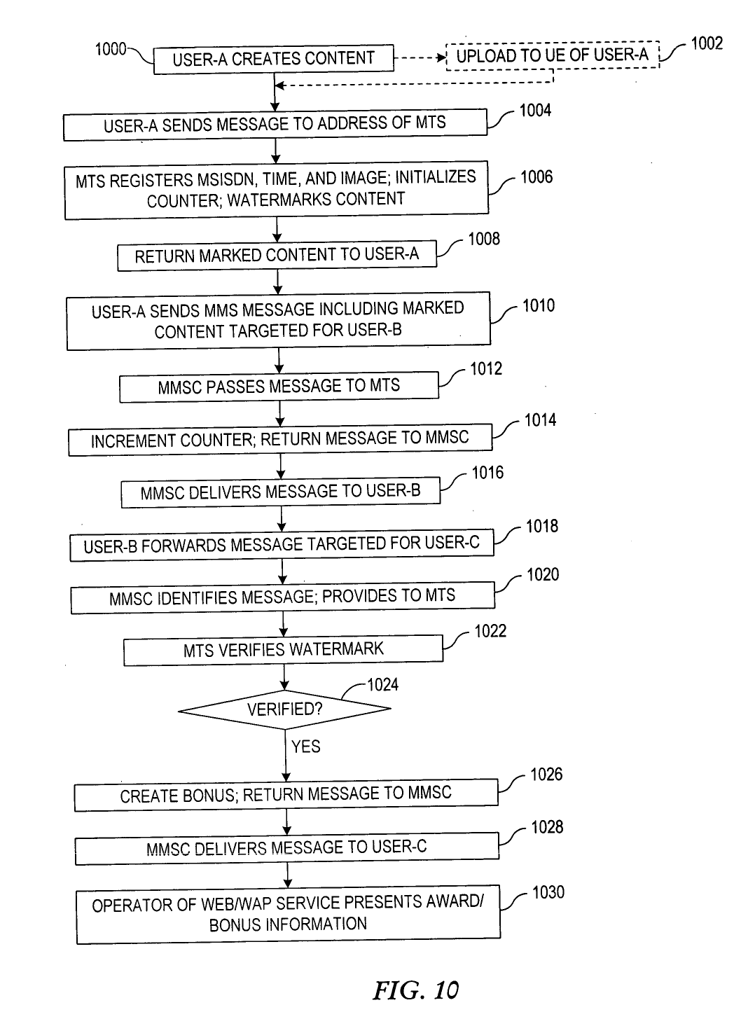

A message tracking and reward system in accordance with the present invention may be implemented in various manners. FIG. 10 is a flow diagram illustrating another embodiment of a manner for tracking messages in accordance with the present invention, where registration is separately performed. In the embodiment of FIG. 10, the user initiates the process using an MMS client, using a special address of the message tracking system. In response, the message tracking system returns a message to the initiating user, who may then start the message proliferation by sending the message to one or more other users.

A user, user-A, creates 1000 content via the UE or otherwise generate content elsewhere and uploads 1002 the content to the UE. User-A sends 1004 the message to the address of the message tracking system (MTS). More particularly, user-A may initiate an MMS client and select the MTS address from a contact list or otherwise enter the MTS address. Such an address may be obtained by user-A by, for example, sending an SMS, MMS, or other request to the network operator that returns the MTS address in response. The user creates the message, adds any desired text (or none), and includes the image or other content. The user selects “send” or other similar UI indicia or button, and the message is sent to the MTS. The text of the message that is separate from the content may not be relevant to the MTS, and the MTS may discard such message text, or save it upon registration. For example, the text may be saved as a text summary of the associated content.

In any event, the content is targeted for the MTS in this embodiment, rather than being sent to the user and intercepted during transit. In the MMS context, the MMSC receives the MMS message targeted for the MTS, and recognizes the MMS address of the MTS. The MMSC may send the message to the MTS over an MM1 interface, external application interface (EAIF), or other interface for communicating MMS messages with an MMSC rather than via a WAP interface.

The MTS registers 1006 the MSISDN (or other subscriber identifier), the timestamp, and the image, as well as initializes a counter and watermarks the content in a manner as previously described. The marked content is returned 1008 to user-A. More particularly, the MTS may return 1008 the watermarked image as an MMS message to the MMSC via an MM1 or EAIF interface, and the MMSC then sends the message to user-A. An indication may be provided in the header to indicate that the message should be free of charge or a reduced fee if desired.

User-A then sends 1010 the message including the marked content to user-B and perhaps other users. More particularly, user-A may start his/her MMS client, pick the address of user-B from a contact list or enter user-B's address directly, and add any message text (e.g., “Hi Bob, check out this picture!”). User-A adds the now watermarked image or other content to the message, and sends 1010 the message towards the intended recipient(s).

The message server, an MMSC in the case of an MMS message, passes the message to the MTS as shown at block 1012. The MMSC identifies the message by recognizing the special detection bits (D) in the image at the stage when image adaptation is being performed, and forwards the message to the MTS which may again be sent via MM1, EAIF, etc. Upon receipt at the MTS, the MTS increments the counter for the user/message combination, and returns the message to the MMSC or other message server as shown at block 1014. The MMSC or other message server delivers 1016 the message to the targeted user-B. User-B may then read the message, and in any event forwards 1018 the message towards user-C. The MMSC identifies the message, such as by recognizing the detection bits, and provides the watermarked message to the MTS as shown at block 1020. The MTS verifies 1022 the watermark in a manner as previously described. If verified as determined at decision block 1024, the MTS updates statistics and creates the bonus for user-A, and returns the message to the MMSC as shown at block 1026. The MMSC delivers 1028 the message to the targeted user-C, and the statistics/bonus information is used by the operator of the WAP/web service to present bonus statistics as shown at block 1030.

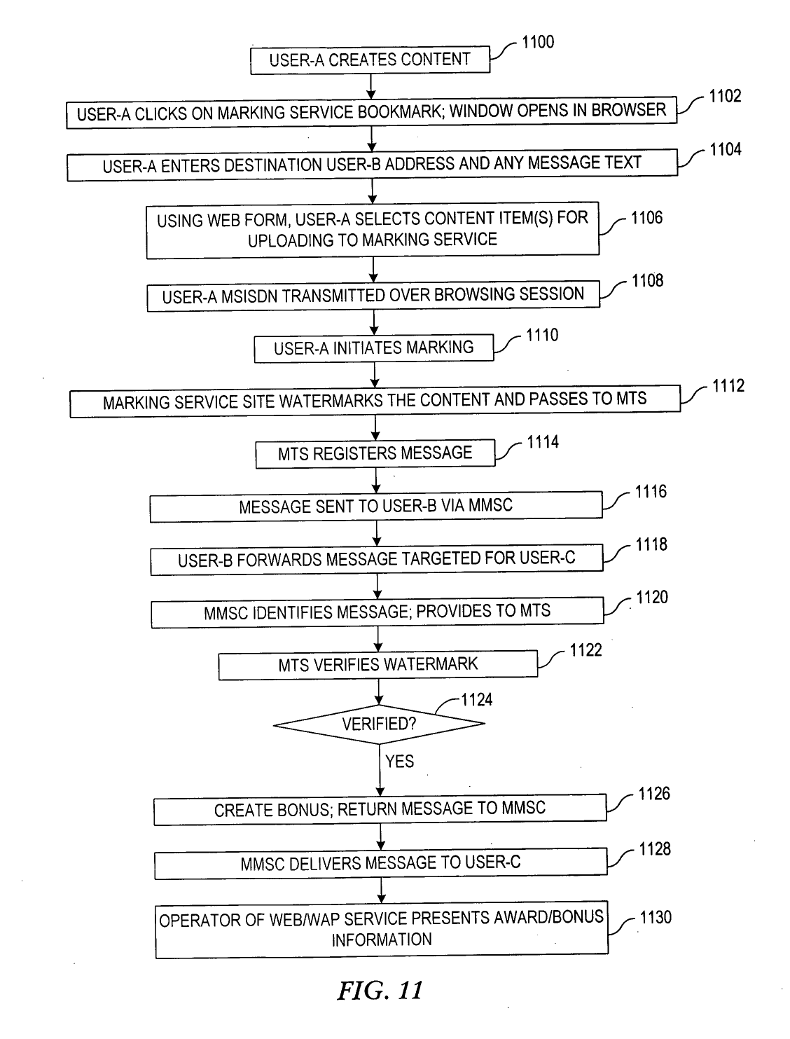

Another exemplary manner in which the present invention may be implemented is illustrated in FIG. 11. FIG. 11 is a flow diagram illustrating an embodiment of a manner for tracking messages in accordance with the present invention, where a separate marking site is accessed to facilitate access to the message tracking system (MTS). In this embodiment, the user uses a specific service, such as a WAP/web service, where content is marked and subsequently passed to the MTS.

Referring to FIG. 11, user-A creates 1100 some content via a UE, or creates the content elsewhere and uploads the content to the user's UE. From the user's UE, user-A clicks on or otherwise selects a marking service, such as selecting a bookmark for a marking service where a browser window is presented as shown at block 1102. User-A enters 1104 the address of a destination user, such as user-B, and enters any desired text into the message. Using the web form, user-A can select content for uploading to the marking service/site, as shown at block 1106. In one embodiment, the web form may emulate the UE MMS browser functionality that allows the user to select content. The MSISDN or other subscriber identifier is transmitted 1108 over the browsing session.

User-A then initiates 1110 the marking process. For example, user-A may select a “send” UI button, icon, or the like, which initiates the processing of the content at the marking service.

When initiated in such a manner, the marking service site watermarks the content and passes the message/content to the MTS, as depicted at block 1112. The MTS registers 1114 the message and the message is sent 1116 to user-B who was identified in user-A's original message. User-B may then read the message, and in any event forwards 1118 the message towards user-C. The MMSC identifies the message, such as by recognizing the detection bits, and provides the watermarked message to the MTS as shown at block 1120. The MTS verifies 1122 the watermark in a manner as previously described. If verified as determined at decision block 1124, the MTS updates statistics and creates the bonus for user-A, and returns the message to the MMSC as shown at block 1126. The MMSC delivers 1128 the message to the targeted user-C, and the statistics/bonus information is used by the operator of the WAP/web service to present bonus statistics as shown at block 1130.

As can be seen, the present invention may be implemented in various manners. The particular implementation embodiments described above are provided for purposes of facilitating an understanding of the invention, and the invention is clearly not limited to the specific examples identified above.

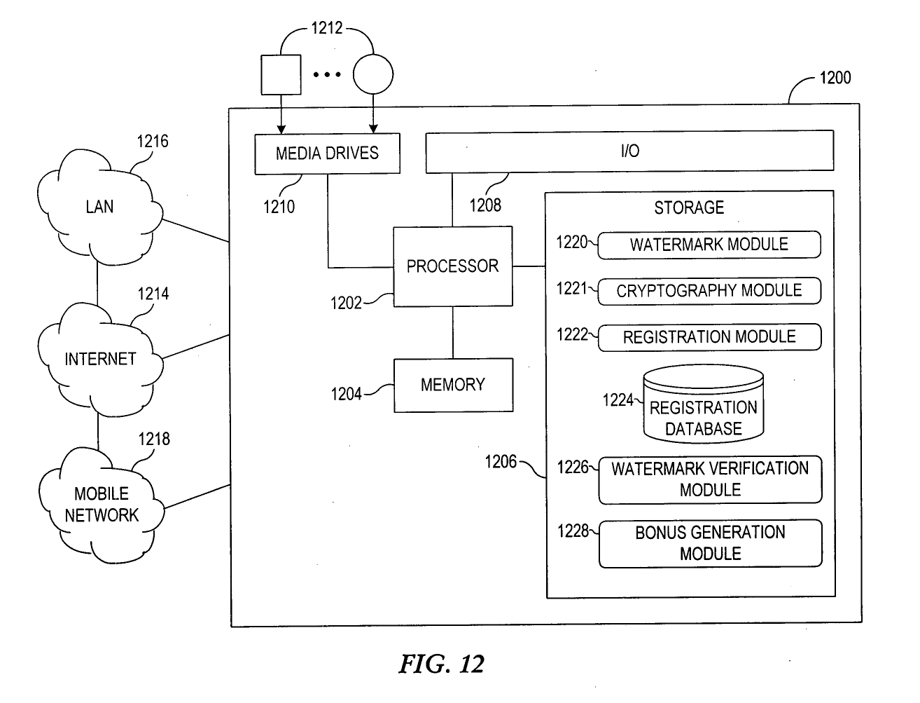

As previously indicated, a message tracking system in accordance with the present invention may be implemented with message server functionality (e.g., MMSC), or may be implemented separately from such message server functionality but operatively connected to the message server in the operator network. FIG. 12 is a block diagram of a representative computing architecture 1200 capable of carrying out functionality of a message tracking system in accordance with the invention, regardless of whether it is implemented as a stand-alone system or in connection with another network entity such as an MMSC. Hardware, firmware, software or a combination thereof may be used to perform the message tracking and bonus functions and operations in accordance with the invention. The embodiment illustrated in FIG. 12 may represent any processing arrangement from which the message tracking and bonus service is to be provided in accordance with the invention.

The representative computing arrangement suitable for performing the clipboard service functions includes a central processing arrangement 1202, which may include one or more microprocessors, microcontrollers, custom-designed processors, or the like. The processor 1202 may be coupled to memory 1204 and storage 1206. The processor 1202 carries out a variety of standard computing functions as is known in the art, as dictated by software and/or firmware instructions. The storage 1206 may represent firmware, hard-drive storage, etc. The storage 1206 may also represent other types of storage media to store programs, such as programmable ROM (PROM), erasable PROM (EPROM), etc. The processor 1202 may communicate with other internal and external components through input/output (I/O) circuitry 1208. The system 1200 may also include one or more media drive devices 1210, including hard and floppy disk drives, CD-ROM drives, DVD drives, and other hardware capable of reading and/or storing information. In one embodiment, software for carrying out the operations in accordance with the present invention may be stored and distributed on CD-ROM, diskette, removable memory, or other form of media capable of portably storing information, as represented by media devices 1212. These storage media may be inserted into, and read by, the media drive devices 1210. Such software may also be transmitted to the device 1200 via data signals, such as being downloaded electronically via a network, such as the Internet 1214, Local Area Network (LAN) 1216, mobile network 1218, and/or any combination thereof.

In accordance with one embodiment of the invention, the storage 1206, memory 1204, and/or media devices 1212 store the various programs and data used in connection with the present invention. In the illustrated embodiment of FIG. 12, the storage 1206 is depicted as storing the various program modules, operable in connection with the processor 1202, although any memory, firmware or other storage could similarly store such program modules. For example, the illustrated embodiment depicts a watermark module 1220 that when executed by the processor 1202 performs the watermarking functions as previously described, such as inserting the appropriate bit patterns into the content. A cryptography module, such as an encryption/decryption module 1221, may also be provided that includes software operable via the processor 1202 to perform the hashing and encryption operations previously described in the watermarking embodiment of FIG. 8. Other watermarking methodologies may also be used in connection with the present invention.

A registration module 1222 may include software/firmware that when executed by the processor 1202 performs the registration functions as previously described. For example, images and other content are registered by storing identifying information, such as by storing such information in a registration database 1224. As was described in connection with FIG. 9, such identifying information may include subscriber identity information such as an MSISDN, a timestamp for the message, a thumbnail or other representation of the content, a MAC, count value, and the like. By registering the image or other content, that image/content can be subsequently identified when the message/content is later forwarded to other users. A watermark verification module 1226 performs such a function. For example, as described in connection with FIG. 9, a watermark may be verified by extracting the watermark information, decrypting the watermark information, and comparing certain decrypted information such as the MSISDN and timestamp to the registered information stored in the registration database 1224. A bonus generation module 1228 is used to generate the reward or other bonus for the users based on their respective content proliferation volumes.

Other modules may be provided at the message tracking system, or alternatively may be provided at other network entities that include an analogous computing architecture as shown in FIG. 12. For example, an ordering service and image database for allowing users to order images from a WAP/web site may be provided at the WAP/web site or other network entity accessible to the message tracking system. An example of such an ordering service and image database was previously described in connection with FIG. 7. Further, a detection module operable with a processor for detecting the detection bits (D) may be provided at the MMSC or other message center to determine whether a message should be forwarded to the message tracking system.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, the present invention is applicable with any type of message transmission where content may be included. For example, the present invention may also be applied in e-mail environments, where an SMTP server or other e-mail server is used in connection with the message tracking system. However, due to the sheer volume and less centralized nature of SMTP servers, the group to which messages may be tracked and statistics recorded may be limited to the group using a particular SMTP server, although communication between multiple SMTP servers is possible. Further, the present invention may be used with any current or future messaging system. Thus, while embodiments of the present invention are primarily described in connection with an MMS environment, the present invention is equally applicable to other messaging systems where content may be associated with a message. For example, the present invention is applicable in Enhanced Messaging System (EMS), evolving Short Message System (SMS), Smart Messaging, or other existing messaging environments, as well as future messaging systems where content can be communicated over networks. It is intended that the scope of the invention be limited not with this detailed description, but rather determined by the claims appended hereto.

1. A method for tracking content communicated over a network, comprising:
receiving at least one message and associated content from an originator of the content over the network;
associating watermark data with the content to provide watermarked content;
registering the watermarked content to record an association of the watermarked content with the originator of the watermarked content;
monitoring for subsequent transmission of the watermarked content over the network to identify the originator of the watermarked content; and
maintaining a content transmission count for each of the originators of the watermarked content that is transmitted over the network.

2. The method of claim 1, further comprising forwarding statistics including at least an identity of the originator of the watermarked content and the corresponding content transmission count to a server, and presenting the forwarded statistics via a site hosted by the server.

3. The method of claim 2, wherein maintaining a content transmission count for each of the originators of the watermarked content comprises maintaining the content transmission count for a plurality of originators of watermarked content, and wherein presenting the forwarded statistics comprises presenting the forwarded statistics in an order based on a relative quantity of transmissions of the plurality of originators of the watermarked content.

4. The method of claim 1, further comprising generating a bonus for the originator of the watermarked content based at least in part on the content transmission count.

5. The method of claim 4, wherein generating a bonus comprises any one or more of providing the originator of the registered content with a reduced network access charge, free network access, a prize, a monetary reward, or publicity.

6. The method of claim 1, wherein associating watermark data with the content comprises embedding electronically perceivable data into the content.

7. The method of claim 1, wherein associating watermark data with the content comprises:
encrypting at least some attributes of the content to provide encrypted data;
hashing at least some of the attributes of the content to provide a machine authentication code (MAC); and
executing a watermark algorithm using the content, the encrypted data, and the MAC as inputs to the watermark algorithm.

8. The method of claim 7, wherein executing the watermark algorithm comprises deriving a bit pattern from the content, encrypted data, and MAC, and inserting the bit pattern into the content.

9. The method of claim 1, further comprising including detection data with the watermarked content, and wherein monitoring for subsequent transmission of the watermarked content comprises detecting the detection data, and verifying the watermark data for the watermarked content that includes the detection data.

10. The method of claim 9, wherein detecting the detection data comprises detecting the detection data at a message routing entity, and further comprising forwarding watermarked content that includes the detection data to a message tracking system.

11. The method of claim 10, wherein the at least one message comprises a Multimedia Messaging Service (MMS) message, and wherein detecting the detection data at a message routing entity comprises detecting the detection data at an Multimedia Messaging Service Center (MMSC).

12. The method of claim 9, wherein verifying the watermark data comprises verifying the watermark data at the message tracking system.

13. The method of claim 1, wherein monitoring for subsequent transmission of the watermarked content comprises detecting the watermarked content transmitted over the network, and verifying the watermark data.

14. The method of claim 13, wherein verifying the watermark data comprises:
extracting the watermark data from the watermarked content;
comparing at least some of the extracted watermark data to a plurality of associations of watermarked content and corresponding content originators; and
designating the watermark data as verified if the extracted watermark data corresponds to any of the plurality of associations of watermarked content and corresponding content originators.

15. The method of claim 14, further comprising decrypting the extracted watermark data, and wherein comparing at least some of the extracted watermark data to a plurality of associations of watermarked content and corresponding content originators comprises comparing at least some of the decrypted watermark data to the plurality of associations of watermarked content and corresponding content originators.

16. The method of claim 1, wherein registering the content comprises storing at least the association of the watermarked content with the originator of the watermarked content in a registration database.

17. The method of claim 1, wherein receiving at least one message and associated content comprises receiving, as an intermediary, a message originating from a first user targeted for at least one other user.

18. The method of claim 1, wherein receiving at least one message and associated content comprises receiving, as an addressee, the message and associated content from the originator of the content, and further comprising returning registered, watermarked content to the originator of the content.

19. The method of claim 1, wherein:
receiving at least one message and associated content comprises receiving the message and associated content from the originator of the content at a web server via a web browsing session;
associating watermark data with the content comprises associating the watermark data with the content at the web server;
registering the watermarked content comprises receiving and registering the watermarked content at a message tracking system; and
monitoring for subsequent transmission of the watermarked content comprises monitoring for subsequent transmission of the watermarked content at the message tracking system.

20. The method of claim 1, further comprising creating the content via user equipment of the originator of the content.

21. The method of claim 1, further comprising uploading the content to user equipment of the originator of the content.

22. The method of claim 1, wherein the message and associated content are received by any of a Multimedia Messaging Service (MMS) message, Enhanced Messaging Service (EMS) message, Short Message Service (SMS), Smart Message, or electronic mail (e-mail) message.

23. A method for tracking content communicated via Multimedia Messaging Service (MMS) messages over a network, comprising:
receiving MMS messages communicated over the network at a Multimedia Messaging Service Center (MMSC);
forwarding the MMS messages to a message tracking system;
associating a watermark with content provided via the MMS messages to generate watermarked content at the message tracking system;
registering the watermarked content at the message tracking system to record an association of the watermarked content with an originator of the watermarked content;
monitoring for subsequent MMS transmission of the watermarked content over the network to identify the originator of the watermarked content; and
maintaining a content transmission count for each of the originators of the watermarked content that is transmitted over the network.

24. A message tracking system coupled to receive messages and associated content from a message routing entity over a network, the message tracking system comprising:
a processing system;
a watermarking module operable via the processing system and configured to associate watermark data with the content to generate watermarked content;
a registration module operable via the processing system and configured to register the watermarked content as being received at the message tracking system;
a watermark verification module operable via the processing system and configured to recognize watermarked content that has been previously registered; and
wherein the registration module tracks a number of times in which the previously registered watermarked content has been received at the message tracking system for each originator of the watermark data.

25. A system for tracking content communicated via messaging between devices operable on a network, comprising:
a message center coupled to the network to receive messages and associated content from message source devices targeted for one or more message destination devices;
a message tracking system coupled to receive the messages and associated content from the message center, the message tracking system comprising:
a processing system;
a watermarking module operable via the processing system and configured to associate watermark data with the content to generate watermarked content;
a registration module operable via the processing system and configured to register the watermarked content as being received at the message tracking system;
a watermark verification module operable via the processing system and configured to recognize watermarked content that has been previously registered; and
wherein the registration module tracks a number of times in which the previously registered watermarked content has been received at the message tracking system for each originator of the watermark data.

26. The system of claim 25, wherein the messages and associated content comprise Multimedia Messaging Service (MMS) messages, and wherein the message center comprises at least one Multimedia Messaging Service Center (MMSC).

27. The system of claim 26, wherein the watermarking module is further configured to associate detection data with the content.

28. The system of claim 27, wherein the at least one MMSC comprises a detection module to identify content having the detection data, and to forward messages having the detection data from the message source devices to the message tracking system.

29. The system of claim 25, wherein the message tracking system is configured to forward the messages and associated content to the message center upon completion of processing by the message tracking system, and wherein the message center is configured to deliver the messages and associated content to the one or more message destination devices.

30. The system of claim 25, wherein the message tracking system further comprises a bonus generation module operable via the processing system and configured to generate a bonus for originators of the content based on the number of times in which the previously registered watermarked content has been received at the message tracking system.

31. The system of claim 25, wherein the system further comprises a server coupled to the message tracking system and configured to host a site to present statistics for at least some of the originators of the content, wherein the statistics include at least the number of times in which the previously registered watermarked content has been received at the message tracking system.

32. The system of claim 31, wherein the server comprises one of a World Wide Web (WWW) server or a Wireless Application Protocol (WAP) server.

33. A computer-readable medium having instructions stored thereon which are executable by a computer system for tracking content communicated over a network by performing steps comprising:
receiving at least one message and associated content from an originator of the content over the network;
associating watermark data with the content to provide watermarked content;
registering the watermarked content to record an association of the watermarked content with the originator of the watermarked content;
monitoring for subsequent transmission of the watermarked content over the network to identify the originator of the watermarked content; and
maintaining a content transmission count for each of the originators of the watermarked content that is transmitted over the network.

34. A message tracking system coupled to receive Multimedia Messaging Service (MMS) messages and associated content from a Multimedia Messaging Service Center (MMSC) over a network, the message tracking system comprising:
means for associating a watermark with the content to provide watermarked content;
means for registering the watermarked content to record an association of the watermarked content with an originator of the watermarked content;
means for identifying subsequent transmission of the watermarked content over the network and for identifying the originator of the watermarked content; and
means for maintaining a content transmission count for each of the originators of the watermarked content that is transmitted over the network.
